(19) United States
(12) Patent Application Publication
(10) Pub. No.: US 2007/0044952 A1
(43) Pub. Date: Mar. 1, 2007

(54) Cooling apparatus of electric device

(76) Inventors: Hiromichi Kuno, Nishikamo-gun (JP); Koshi Torii, Iwakura-shi (JP)

Correspondence Address: KENYON & KENYON LLP, 1500 K STREET N.W., SUITE 700, WASHINGTON, DC, 20005, US

(21) Appl. No.: 10/556,537

(22) PCT Filed: Dec. 15, 2004
(86) PCT No.: PCT/IB04/04141

§ 371 Date: Nov. 14, 2005

(30) Foreign Application Priority Data
Dec. 24, 2003 (JP) 2003-427550

(51) Int. Cl. G05D 23/00

(52) U.S. Cl. 165/287

(57) ABSTRACT

Semiconductor elements (800 to 850) are obtained by molding IGBT and diodes to form an inverter for motor, each of which is in abutting contact with each of first cooling units (1100 to 1106). Semiconductor elements (860 to 910) are obtained by molding IGBT and diodes to form an inverter for generator, each of which is in abutting contact with each of the first cooling unit (1100 to 1106) and second cooling units (1200 to 1204). The heat value generated by the semiconductor elements (800 to 850) is larger than that generated by the semiconductor elements (860 to 910). A flow rate of a cooling water flowing through the first cooling units (1100 to 1106) is higher than that of the cooling water flowing through the second cooling units (1200 to 1204)

### BACKGROUND OF THE INVENTION

1. Field of Invention

The invention relates to a cooling apparatus of an electric device, and more particularly, to a cooling apparatus of a plurality of electric devices each having different heat value.

2. Description of Related Art

Coping with recent environmental issues, development of hybrid vehicles using driving force of the motor, fuel cell vehicles, electric vehicles and the like have been increasingly focused. The vehicle of the aforementioned type is generally equipped with such electric device as an inverter, capacitor, and a converter which regulates electricity from a battery (at about 300V, for example) into a desired state so as to be supplied to a motor. As those electric devices generate heat upon supply of electricity, they have to be cooled by circulating cooling water in cooling passage.

JP-A-2001-25254 discloses a cooling system for a power converter that smoothes the temperature rise in a semiconductor element of the power converter so as to be efficiently cooled. The cooling system disclosed in the aforementioned publication transmits the heat generated by the semiconductor element of the power converter to a radiation fin provided in an air channel via a heat receiving plate and air is forced to flow by a electric blower in the air channel such that heat is diffused into atmosphere from the radiation fins. The cooling system is provided with the air channel having its cross section area reduced from upwind to downwind, a plurality of radiation fins arranged within the air channel in series from upwind to downwind, and a plurality of heat receiving plates provided at the respective radiation fins such that heat generated by the semiconductor elements of the power converter is transmitted to the corresponding radiation fins.

In the cooling system disclosed in the aforementioned publication, the heat generated by the semiconductor elements of the power converter is transmitted to the respective radiation fins via the corresponding heat receiving plates. As the radiation fins are arranged in the air channel having its cross section area reduced from upwind to downwind, the heat diffused from the respective radiation fins may be uniformized.

Assuming that a plurality of electric devices (semiconductor elements), each having different heat value, is cooled by the aforementioned cooling system disclosed in the publication, if the cooling level of the cooling system is determined in accordance with the electric device that generates relatively larger heat value, the electric device that generates relatively smaller heat value may be excessively cooled. Meanwhile, in the aforementioned case, if the cooling level of the cooling system is determined in accordance with the electric device that generates relatively smaller heat value, the electric device that generates relatively larger heat value may not be sufficiently cooled.

### SUMMARY OF THE INVENTION

It is an object of the invention to provide a cooling apparatus of a plurality of electric devices, which is capable of cooling those electric devices at different cooling levels in accordance with heat values generated by the respective electric devices.

A cooling apparatus of electric devices including a first electric device and a second electric device that generates a larger heat value than that of the first electric device is provided with cooling units that circulate a cooling medium for cooling the first and the second electric devices at different cooling intensities in accordance with heat values generated by the first and the second electric devices, respectively.

According to the aforementioned aspect of the invention, the cooling unit in which the cooling medium for cooling the respective electric devices serves to cool each of the electric devices at the different level in accordance with the heat value generated by the respective electric devices. This makes it possible to provide the cooling apparatus of the electric device, which is capable of cooling a plurality of electric devices at different cooling levels in accordance with the heat values generated by the respective electric devices.

In the cooling apparatus, the cooling units include first cooling units in abutting contact with the first electric device and second cooling units in abutting contact with the second electric device. The cooling apparatus is provided with a first cooling passage formed within the first cooling unit for allowing circulation of the cooling medium that cools the electric devices, a second cooling passage formed within the second cooling unit for allowing circulation of the cooling medium that cools the electric devices by quantity larger than that of the cooling medium circulating through the first cooling passage, an inlet that is connected to the cooling unit and allows the cooling medium to flow into the cooling passage, and an outlet that is connected to the cooling unit and allows the cooling medium to flow from the cooling passage.

According to the aforementioned aspect of the invention, the first cooling unit is provided in abutting contact with the first electric device. Provided within the first cooling unit is the first cooling passage that allows circulation of the cooling medium for cooling the electric devices. Meanwhile the second cooling unit is provided in abutting contact with the second electric device. Provided within the second cooling unit is the second cooling passage that allows circulation of the cooling medium for cooling the electric devices by quantity larger than that of the cooling medium flowing through the first cooling passage. Each of the cooling units is connected with the inlet that allows the cooling medium to flow into the respective cooling passages, and the outlet that allows the cooling medium to be discharged from the cooling passages. This may allow the first cooling unit to cool the first electric device, and the second cooling unit to cool the second electric device. The heat value generated by the second electric device is larger than that generated by the first electric device. The flow rate of the cooling medium that flows through the second cooling unit is higher than that of the cooling medium that flows through the first cooling unit. Accordingly, the cooling apparatus according to the invention is capable of cooling the electric device by circulating the cooling medium at the cooling level in accordance with the heat value generated by the electric device. As a result, the cooling apparatus is capable of cooling a plurality of electric devices at different cooling levels in accordance with heat values generated by the respective electric devices.

In the cooling apparatus, a cross section area of the second cooling passage is larger than that of the first cooling passage.

According to the aforementioned aspect of the invention, the cross section area of the second cooling passage is larger than that of the first cooling passage. As a result, the flow rate of the cooling medium that flows through the second cooling unit may be increased to be higher than that of the cooling medium that flows through the first cooling unit.

In the cooling apparatus, the cooling unit includes a flow rate reducing member that reduces a flow rate of the cooling medium that circulates through the cooling passage as a temperature of the cooling medium decreases.

According to the aforementioned aspect of the invention, each of the cooling units includes a flow rate reducing member that serves to reduce the flow rate of the cooling medium flowing through the cooling passage as decrease in its temperature. Accordingly the flow rate of the cooling medium flowing through the cooling unit in abutting contact with the electric device that generates relatively smaller heat value becomes lower than that of the cooling medium flowing through the cooling unit in abutting contact with the electric device that generates relatively larger heat value. As a result, the electric device may be cooled by the cooling medium at the level in accordance with the heat value.

In the cooling apparatus, the flow rate reducing member includes an element that reduces the cross section area of the cooling passage as the temperature of the cooling medium decreases.

According to the aforementioned aspect of the invention, the flow rate reducing member serves to reduce the cross section area of the cooling passage as decrease in the temperature of the cooling medium. Accordingly, when the electric device is in a low temperature state, the flow rate of the cooling medium flowing through the respective electric devices is restrained to lower the cooling level, thus preventing excessive cooling of the electric device.

In the cooling apparatus, the flow rate reducing member is formed of a shape memory alloy material.

According to the aforementioned aspect of the invention, the flow rate reducing member is formed of the shape memory alloy material. The shape memory alloy as the flow rate reducing member deforms in a state of a predetermined temperature of the cooling medium to regulate the flow rate of the cooling medium without requiring complicated control operations.

In the cooling apparatus, the cooling unit includes a cooling fin provided within the cooling passage so as to project inward thereof.

According to the aforementioned aspect of the invention, cooling fins each projecting toward the inside of the cooling passage are provided in the respective cooling units. Those cooling fins serve to increase the contact area between the cooling unit and the cooling medium, thus improving the efficiency for cooling the respective cooling units.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic view of a vehicle equipped with a cooling apparatus that employs a cooling structure according to an embodiment of the invention;

FIG. 2 is a perspective view that represents a structure of a semiconductor element as a whole;

FIG. 3 is a perspective view that represents a cooling apparatus as a whole;

FIG. 4 is a front view that shows an arrangement of the cooling units and the semiconductor elements;

FIGS. 5A and 5B are sectional views each representing the inside of cooling units; and

FIG. 6 is a sectional view that shows the inside of the cooling unit.

### DETAILED DESCRIPTION OF PREFERRED EMBODIMENT

An embodiment of the invention will be described referring to the drawings. In this embodiment, the identical elements having the same descriptions and functions are designated with identical reference numerals, and explanations of those elements, thus, will not be repeatedly described.

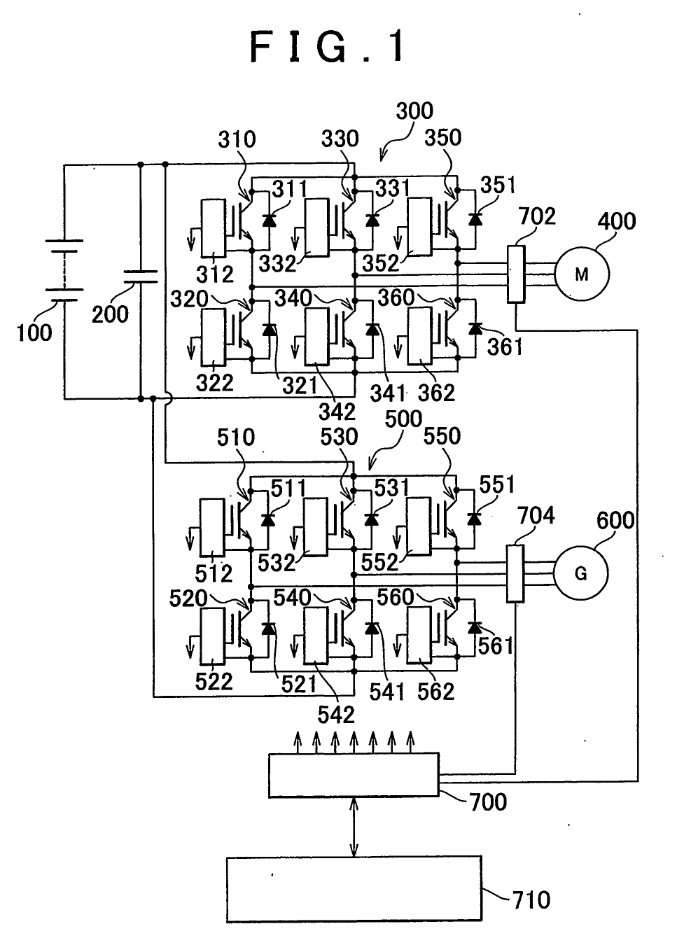

Referring to FIG. 1, a vehicle equipped with a cooling apparatus of electric devices according to an embodiment of the invention includes a battery 100, a capacitor 200, an inverter 300 for motor, a motor 400, an inverter 500 for generator, a generator 600, a signal generation circuit 700, and a control circuit 710. The embodiment of the invention will be described with respect to a hybrid vehicle equipped with an engine (not shown). It is to be understood that application of the invention is not limited to the hybrid vehicle as aforementioned. It may be applied to, for example, a fuel cell vehicle, an electric vehicle and the like.

The battery 100 is a combination battery formed by connecting a plurality of battery modules each formed of a plurality of cells connected in series. The battery 100 has a voltage value of about 300 V, for example.

The capacitor 200 is connected in parallel with the battery 100. The capacitor 200 temporarily stores the electric charge to smooth the electric power supplied from the battery 100. The electric power smoothed by the capacitor 200 is supplied to the inverter 300 for motor.

The inverter 300 for motor includes six IGBTs (Insulated Gate Bipolar Transistor) 310 to 360, six diodes 311 to 361 each connected in parallel with the corresponding IGBT so as to apply electric current from the emitter side to the collector side of the IGBT, and six IGBT drive circuits 312 to 362 each connected to the corresponding IGBT so as to be driven in accordance with signals generated by the signal generation circuit 700. The IGBT 310 and IGBT 320, IGBT 330 and IGBT 340, and IGBT 350 and IGBT 360 are connected in series, respectively so as to correspond with the respective phases (U phase, V phase, W phase). The inverter 300 for motor serves to convert the electric current supplied from the battery 100 from the direct current into the alternating current so as to be supplied to the motor 400 in response to switching of the respective IGBT between On and Off. As the inverter 300 for motor may be formed using general technology, no further explanation with respect to the inverter will be described.

The motor 400 is a three-phase motor having a rotating shaft connected to a drive shaft (not shown) of the vehicle. The vehicle runs by using the driving force supplied from the motor 400.

Likewise the inverter 300 for motor, the inverter 500 for generator includes six IGBTs 510 to 560, six diodes 511 to 561 each connected in parallel with the corresponding IGBT so as to apply electric current from the emitter side to the collector side of the IGBT, and six IGBT drive circuits 512 to 562 each connected to the corresponding IGBT so as to be driven in accordance with signals generated by the signal generation circuit 700. The IGBT 510 and IGBT 520, IGBT 530 and IGBT 540, and IGBT 550 and IGBT 560 are connected in series, respectively so as to correspond to the respective phases (U phase, V phase, W phase). The inverter 500 for generator serves to convert the electric current generated by the generator 600 from the alternating current into the direct current so as to be supplied to the battery 100 in response to switching of the IGBT between On and Off. As the inverter 500 for generator may be formed using general technology, no further explanation with respect to the inverter will be described.

The generator 600 has the same structure as that of the three-phase motor. A rotating shaft of the generator 600 is connected to a crankshaft (not shown) of the engine, and driven by the driving force from the engine for generating power. The power generated by the generator 600 is directly supplied to the motor 400 or converted from the alternating current into the direct current by the inverter 500 for generator, and then smoothed by the capacitor 200 so as to charge the battery 100.

Substantially high electric power is instantaneously or continuously applied to the inverter 300 for motor upon drive of the motor 400. Meanwhile, the chance of the generator 600 for generating electric power is less than that of the motor 400. Also the electric current flowing into the inverter 500 for generator is lower than that flowing into the inverter 300 for motor. Accordingly the heat value of the inverter 300 for motor is larger than that of the inverter 500 for generator.

The signal generation circuit 700 is controlled by the control circuit 710 such that the signal that commands each switching between On and Off of the IGBTs is generated. The control circuit 710 calculates an On/Off ratio (duty ratio) of the IGBT based on a depression amount of an accelerator pedal (not shown), an opening degree of a throttle valve (not shown) and the like. As the signal generation circuit 700 and the control circuit 710 may be formed using general technology, no further explanation of those components will be described.

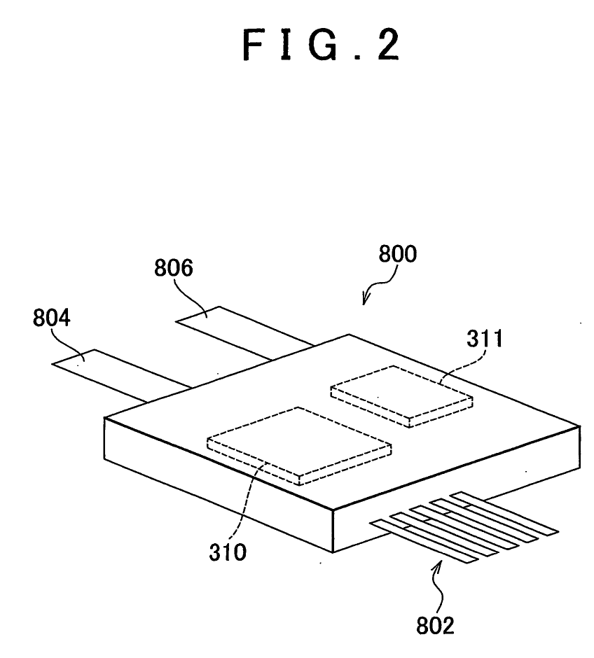

Structures of the IGBTs and the diodes will be described with respect to the IGBT 310 and the diode 311 referring to FIG. 2. As the structures of other IGBTs and diodes are the same as those of the IGBT 310 and the diode 311, the explanation with respect to those structures, thus, are not repeatedly described herein.

Referring to FIG. 2, the IGBT 310 and the diode 311 are molded using resin material. The element formed by molding the IGBT 310 and the diode 311 will be referred to as a semiconductor element 800. The semiconductor element 800 includes a control terminal 802, a first conductor 804, and a second conductor 806. The control terminal 802 is connected to the IGBT 310, and the first and the second conductors 804, 806 are connected to the IGBT 310 and the diode 311.

Likewise the IGBT 310 and the diode 311, other IGBTs and diodes are molded into semiconductor elements 810 to 910.

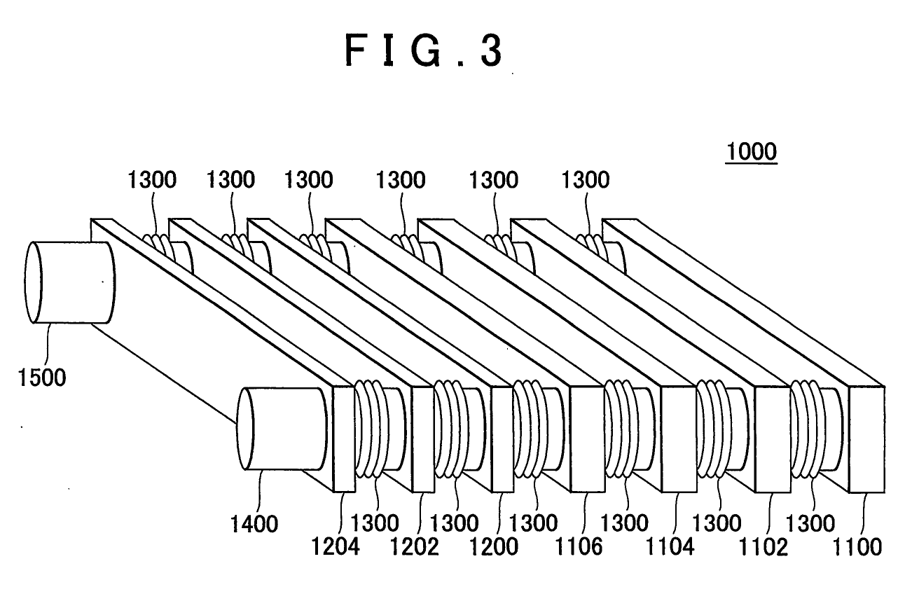

A structure of a cooling apparatus 1000 according to the embodiment of the invention will be described referring to FIG. 3. The cooling apparatus 1000 includes four first cooling units 1100 to 1106, three second cooling units 1200 to 1204, bellows 1300 each connecting the adjacent cooling units, an inlet 1400 and an outlet 1500. The number of those cooling units is not limited to the one as aforementioned, but may be determined to an arbitrary number in accordance with the number of semiconductor elements to be cooled.

The respective cooling units are arranged at predetermined intervals with one another. Both ends of each of the cooling units have holes (described later), through which the bellows 1300 are attached to connect the cooling units. Cooling water for cooling the semiconductor elements is circulated through the inside of the cooling unit.

The accordion-like bellows 1300 allows fine adjustment of the space between the adjacent cooling units. The inlet 1400 and the outlet 1500 are attached to one surface of the second cooling unit 1204, and connected to the holes formed in the cooling unit 1200 so as to be joined with the bellows 1300 via the holes formed in the respective cooling units. The inlet 1400 admits the cooling water to flow into the cooling apparatus 1000. The cooling water passes through the respective cooling units and bellows so as to be discharged from the outlet 1500. The same cooling water is circulated through each of the respective cooling units of the cooling apparatus 1000.

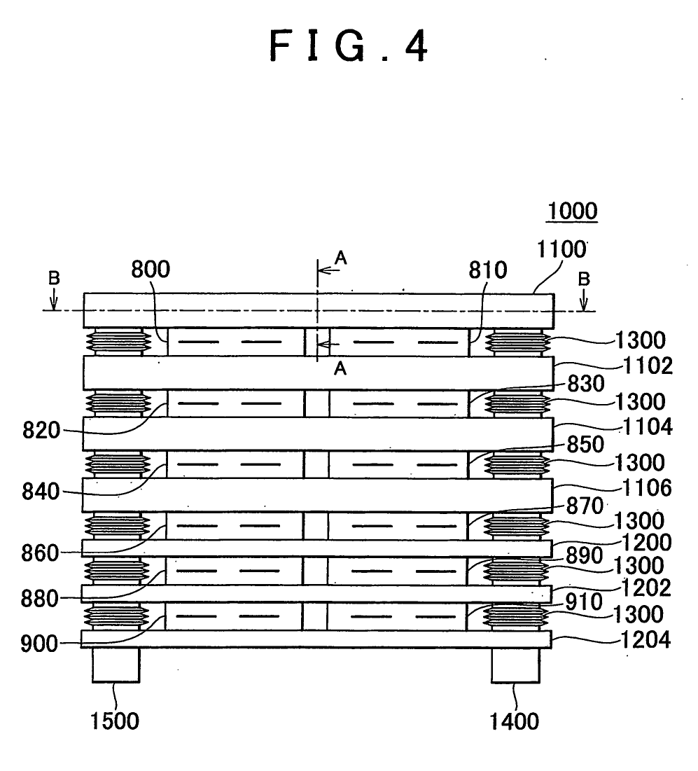

Referring to FIG. 4, the structure of the cooling apparatus 1000 will be described. The semiconductor elements 800, 810 are provided in abutting contact with the first cooling units 1100 and 1102 therebetween. The semiconductor elements 820, 830 are provided in abutting contact with the first cooling units 1102 and 1104 therebetween. The semiconductor elements 840, 850 are provided in abutting contact with the first cooling units 104 and 1106 therebetween. The arrangement of the cooling units and the semiconductor elements is not limited to the one as aforementioned. The state where the semiconductor element is in abutting contact with the cooling unit includes the state where the semiconductor element is directly provided within the cooling unit (within the cooling passage as described later).

The semiconductor elements 800 to 850 are produced by molding the IGBTs and the diodes, which constitute the inverter 300 for motor. The semiconductor elements 800 and 810 correspond to the U phase. The semiconductor elements 820 and 830 correspond to the V phase. The semiconductor elements 840 and 850 correspond to the W phase.

The semiconductor elements 860, 870 are provided in abutting contact with the first and the second cooling units 1106 and 1200 therebetween. The semiconductor elements 880, 890 are provided in abutting contact with the second cooling units 1200 and 1202 therebetween. The semiconductor elements 900, 910 are provided in abutting contact with the second cooling units 1202 and 1204 therebetween. The arrangement of the cooling units and the semiconductor elements is not limited to the one as aforementioned. The state where the semiconductor element is in abutting contact with the cooling unit includes the state where the semiconductor element is directly provided within the cooling unit (within the cooling passage as described later).

The semiconductor elements 860 to 910 are produced by molding the IGBTs and the diodes, which constitute the inverter 500 for generator. The semiconductor elements 860 and 870 correspond to the U phase. The semiconductor elements 880 and 890 correspond to the V phase. The semiconductor elements 900 and 910 correspond to the W phase.

There is a variation among the aforementioned semiconductor elements with respect to the size. As the cooling units are joined with the bellows 1300, the space between the adjacent cooling units may be finely adjusted such that each of the cooling units becomes in close contact with the corresponding semiconductor element.

In this embodiment, the cooling apparatus is structured to cool the semiconductor elements that constitute the inverter 300 for motor and the inverter 500 for generator. However, such structure is not limited to the one as aforementioned. For example, it may be structured to cool the semiconductor elements that constitute an inverter and a converter, or the semiconductor elements that constitute a converter and the capacitor. Alternatively the cooling apparatus according to the embodiment may be structured to cool three or more electric devices, for example, the semiconductor elements that constitute the inverter, the semiconductor elements that constitute the converter, and the capacitor. The cooling apparatus may be structured to cool various combinations of electric devices.

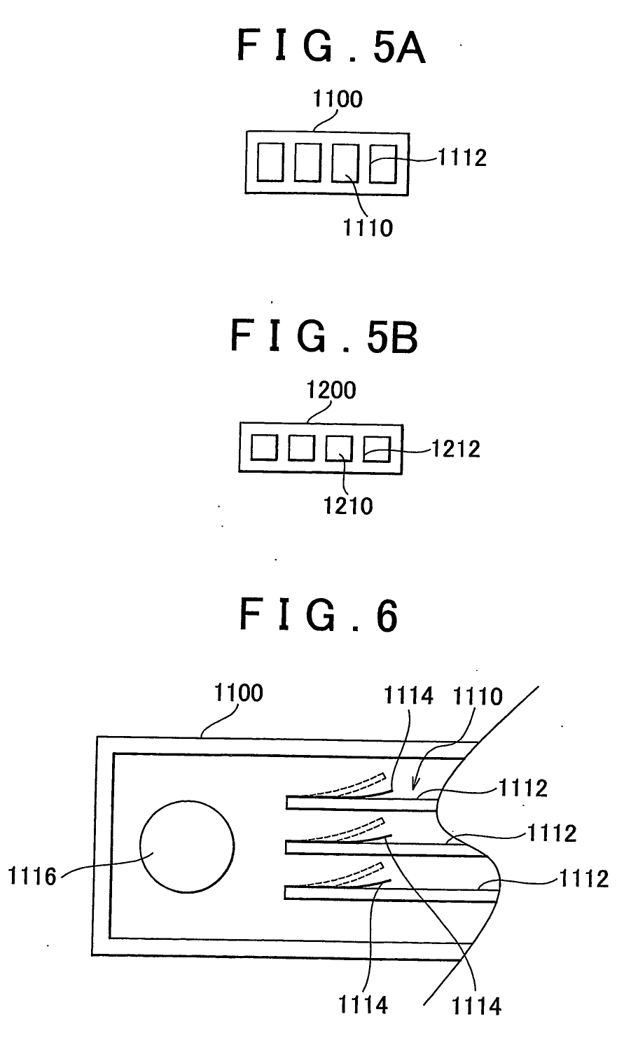

FIG. 5A is a sectional view of the first cooling unit 1100 taken along line A-A of FIG. 4. As shown in FIG. 5A, cooling passages 1100 through which the cooling water passes are formed within the first cooling unit 1100. Cooling fins 1112 are attached within the cooling passage 1110 so as to project toward the inside thereof. As each of the other first cooling units has the same structure as that of the first cooling unit 1100, the detailed explanation with respect to such structure will not be described herein. The number of the cooling fins 1112 is not limited to three.

Likewise the inside of the first cooling unit 1100, the cooling passages 1210 through which the cooling water passes are formed within the second cooling unit 1200 as shown in FIG. 5B. Cooling fins 1212 are attached within the cooling passage 1210 so as to project toward the inside thereof. As each of the other second cooling units has the same structure as that of the second cooling unit 1200. The detailed explanation with respect to the structure of the other second cooling unit will not be described herein. The number of the cooling fins 1212 is not limited to three.

The cross section area of the cooling passage 1110 is larger than that of the cooling passage 1210. Accordingly the flow rate of the cooling water flowing through the first cooling unit 1100 is higher than that of the cooling water flowing through the second cooling unit 1200. As a result, the level for cooling the first cooling unit is higher (exhibiting higher cooling capability) than that for cooling the second cooling unit. The cooling intensity of the first cooling units represented by the flow rate of the cooling medium, cooling level, the susceptibility to be cooled or the like, with respect to the semiconductor elements is higher than that of the second cooling units with respect to the semiconductor elements.

The cooling system may be structured such that the cooling passages 1110 and 1210 have the same cross section areas, and the flow rate of the cooling water flowing through the first cooling unit 1100 is increased to be higher than that of the cooling water flowing through the second cooling unit 1200. The state where high flow rate of the cooling water includes the state where the cooling water flows at high speeds.

The cross section of the first cooling unit 1100 taken along line B-B shown in FIG. 4 will be described referring to FIG. 6. Each of shape memory alloy members 1114 is provided on a side surface of the cooling fin 1112. The shape memory alloy member 1114 has its one end moving apart from the side surface of the cooling fin 1112 so as to reduce the cross section area of the cooling unit 1110 as indicated by dashed line as the cooling water temperature decreases. This makes it possible to reduce the flow rate of the cooling water. Other cooling unit is provided with the same shape memory alloy member, thus the detailed explanation of such structure in the other cooling unit is not repeatedly described.

The shape memory alloy member which is larger than that in the first cooling unit may be provided in the second cooling unit. It is possible to provide the shape memory alloy member in the second cooling unit, which starts reducing the cross section area of the cooling unit at a temperature lower than the temperature at which the shape memory alloy member provided in the first cooling unit starts reducing the cross section area

Both ends of the lower surface of the first cooling unit 1100 has bellows fixing holes 1116 into which the bellows 1300 are inserted. The bellows fixing holes 1116 are formed in both ends of the upper and lower surfaces of other cooling units. The bellows fixing holes are formed in the lower surface of the second cooling unit 1204 into which the inlet 1400 and the outlet 1500 are inserted and fixed instead of the bellows 1300.

The effect derived from the structure of a PCU (Power Control Unit) that includes electric devices, for example, the inverter, capacitor, converter and the like according to the embodiment will be described.

The semiconductor elements 800 to 850 are cooled at both (upper and lower) surfaces by the first cooling units 1100 to 1106. The semiconductor elements 860 to 910 are cooled at both surfaces by the first cooling unit 1106 and the second cooling units 1200 to 1204.

The semiconductor elements 800 to 850 constitute the inverter 300 for motor, and the semiconductor elements 860 to 910 constitute the inverter 500 for generator. The heat value generated by those semiconductor elements 800 to 850 is larger than that generated by those semiconductor elements 860 to 910. Meanwhile, the cross section area of the cooling passage of the first cooling unit is larger than that of the cooling passage of the second cooling unit. Accordingly the flow rate of the cooling water flowing through the first cooling unit is higher than that of the cooling water flowing through the second cooling unit. The cooling level for the first cooling units is higher than that for the second cooling units. The first cooling units exhibiting higher cooling level serve to cool the semiconductor elements 800 to 850 that generate larger heat value, and part of the first cooling units and the second cooling units exhibiting lower cooling level serve to cool the semiconductor elements 860 to 910 that generate smaller heat value. This makes it possible to cool the semiconductor elements at different cooling levels in accordance with the heat values generated by the respective semiconductor elements. This may prevent excessive cooling of the semiconductor elements or insufficient cooling of the semiconductor elements.

Each of the cooling units has cooling fins therein each projecting toward the inside of the cooling passage. This may enlarge the area of the cooling unit in contact with the cooling water, thus increasing the cooling level of the cooling unit.

In the case where the temperature of the cooling water decreases owing to the low temperature (small heat value) of the semiconductor element, the shape memory alloy member works to reduce the cross section area of each of the cooling passages, thus restricting the flow of the cooling water. This may prevent increase in the cooling level of each of the cooling units such that the semiconductor elements are cooled at appropriate levels in accordance with the respective heat values. This may prevent excessive cooling of the semiconductor elements.

In the cooling apparatus of electric devices according to the embodiment of the invention, the first cooling units serve to cool the semiconductor elements that constitute the inverter for motor, and part of the first cooling units and the second cooling units serve to cool the semiconductor elements that constitute the inverter for generator. The heat value generated by the semiconductor elements that constitute the inverter for motor is larger than that generated by the semiconductor elements that constitute the inverter for generator. The flow rate of the cooling water flowing through the first cooling unit is higher than that of the cooling water flowing through the second cooling unit. Accordingly the semiconductor elements may be cooled at the cooling level appropriately in accordance with the heat value generated by the respective semiconductor elements.

It is to be understood that the embodiment of the invention is described for purposes of illustration and not for limitation. The scope of the invention, thus is to be determined soley by the appended claims, and the claims include all modifications in the equivalents within the scope of the invention.

1. A cooling apparatus of electric devices comprising:
a cooling unit that circulates a cooling medium for cooling a first electric device and a second electric device, which generates a larger heat value than that of the first electric device, at different cooling intensities in accordance with the respective heat values generated by each of the first and the second electric devices.

2. The cooling apparatus according to claim 1, wherein the cooling unit comprises a first cooling unit in contact with the first electric device and a first cooling passage formed within the first cooling unit for allowing circulation of the cooling medium that cools the first electric device;
and a second cooling unit in contact with the second electric device and a second cooling passage formed within the second cooling unit for allowing circulation of the cooling medium that cools the second electric device, whereby a greater quantity of cooling medium flows through the second cooling passage than the first cooling passage, the cooling apparatus further comprising:
an inlet that is connected to each of the first and second cooling units and allows the cooling medium to flow into the cooling passages; and
an outlet that is connected to each of the first and second cooling units and allows the cooling medium to flow from each of the cooling passages.

3. The cooling apparatus according to claim 2, wherein a cross section area of the second cooling passage is larger than that of the first cooling passage.

4. The cooling apparatus according to claim 2, wherein each of the first and the second cooling units comprises a flow rate reducing member that reduces a flow rate of the cooling medium that flows through each of the first and the second cooling passages as a temperature of the cooling medium decreases.

5. The cooling apparatus according to claim 4, wherein the flow rate reducing member comprises an element that reduces the cross section area of each of the first and the second cooling passages as the temperature of the cooling medium decreases.

6. The cooling apparatus according to claim 4, wherein the flow rate reducing member is formed of a shape memory alloy material.

7. The cooling apparatus according to claim 2, wherein each of the first and the second cooling units comprises at least one cooling fin provided within each of the first and the second cooling passages so as to project inward thereof.

8. The cooling apparatus according to claim 2, wherein the flow rate of the cooling water flowing through the second cooling unit is increased to be higher than that of the cooling water flowing through the first cooling unit.

9. The cooling apparatus according to claim 3, wherein each of the first and the second cooling units comprises a flow rate reducing member that reduces a flow rate of the cooling medium that flows through each of the first and the second cooling passages as a temperature of the cooling medium decreases.

10. The cooling apparatus according to claim 9, wherein the flow rate reducing member comprises an element that reduces the cross section area of each of the first and the second cooling passages as the temperature of the cooling medium decreases.

11. The cooling apparatus according to claim 5, wherein the flow rate reducing member is formed of a shape memory alloy material.

12. The cooling apparatus according to claim 9, wherein the flow rate reducing member is formed of a shape memory alloy material.

13. The cooling apparatus according to claim 10, wherein the flow rate reducing member is formed of a shape memory alloy material.

14. The cooling apparatus according to claim 3, wherein each of the first and the second cooling units comprises at least one cooling fin provided within each of the first and the second cooling passages so as to project inward thereof.

15. The cooling apparatus according to claim 4, wherein each of the first and the second cooling units comprises at least one cooling fin provided within each of the first and the second cooling passages so as to project inward thereof.

16. The cooling apparatus according to claim 9, wherein each of the first and the second cooling units comprises at least one cooling fin provided within each of the first and the second cooling passages so as to project inward thereof.
